(19) United States
(12) Patent Application Publication
(10) Pub. No.: US 2024/0017804 A1
(43) Pub. Date: Jan. 18, 2024

(54) UNDERWATER SPEAKING DEVICE

(71) Applicant: Scuba Tuba Inc., Honolulu, HI (US)

(72) Inventors: Kendal Vercoe, Honolulu, HI (US); Joshua Brady Thomas, Honolulu, HI (US); Evan Collier, Nyack, NY (US)

(21) Appl. No.: 18/221,181

(22) Filed: Jul. 12, 2023

Related U.S. Application Data
(60) Provisional application No. 63/388,441, filed on Jul. 12, 2022.

(51) Int. Cl. B63C 11/02; G10K 11/22

(52) U.S. Cl. CPC B63C 11/02; G10K 11/22

(57) ABSTRACT

A speaking device may be fitted to a user's mouth or mouth and nose and sealed against the user's face in order to provide a sealed airspace for oral communications while underwater. The speaking device is collapsible while not in use and may be extended prior to use in order to provide a larger volume of sealed airspace in which the user can communicate. When extended and fit to the user's face an exhalation of air may be used to purge water from the device interior via a distal regulator port and allow for brief communication. Alternately, an air regulator may be coupled to the regulator port to aid in purging water and/or provide breathable air for prolonged communication. Alternately, an LPI line may be connected to an LPI port of the device and operated to aid in purging water and/or provide breathable air for prolonged communication.

### RELATED CASES

This non-provisional patent application claims priority to U.S. Provisional Patent Application No. 63/388,441, filed Jul. 12, 2022, the disclosure of which is hereby incorporated by reference in its entirety.

### FIELD

The disclosed technology pertains to a device that allows a user to speak or otherwise verbally communicate while underwater.

### BACKGROUND

Swimming, diving, and other water activities are hobbies for some and a vocation for others. Water activities come with a number of risks and limitations, some that are quickly learned by children while playing in a pool, while others are less obvious and only become apparent in certain settings. As one example, a significant limitation of equipment assisted diving is an inability for divers to easily communicate with each other during a dive, both because their airways are occupied by mouthpieces and other breathing apparatuses, and because water is not an effective carrier of the soundwaves produced during verbal communication. An inability to communicate underwater is at best a major inconvenience, and in some cases can be extremely dangerous both for inexperienced drivers and for seasoned professionals.

Conventional approaches to addressing these limitations include complex systems of hand signals, sign language, or lighting signals, percussive noisemakers (e.g., a sharp metallic noise transmits through water well compared to speech), and the like. Such approaches have varying limitations both in speed of communication (e.g., hand signals communication information slowly and require constant visual focus) and flexibility (e.g., hand signals and noisemakers are limited to a certain set of pre-determined meanings that may not be readily adapted to every communication need). Other conventional approaches include complex and expensive electronic equipment that adds significant weight, complexity, and potential for erroneous operation. Such disadvantages and distractions are not ideal in ordinary circumstances and can become dangerous or deadly distractions for a diver.

What is needed, therefore, is an improved system for allowing speech and other verbal communications while underwater.

### BRIEF DESCRIPTION OF THE DRAWINGS

The drawings and detailed description that follow are intended to be merely illustrative and are not intended to limit the scope of the invention as contemplated by the inventors.

FIG. 1 is a front perspective view of an exemplary speaking device.

FIG. 2 is a rear perspective view of the speaking device of FIG. 1.

FIG. 3 is a front perspective view of the speaking device of FIG. 1 in a collapsed state.

FIG. 4 is a top-down view of the speaking device of FIG. 1.

FIG. 5 is a bottom-up view of the speaking device of FIG. 1.

FIG. 6 is a side elevation view of the speaking device of FIG. 1.

FIG. 7 is a cross-sectional side elevation view of the speaking device of FIG. 1.

FIG. 8 is an exploded side elevation view of the speaking device of FIG. 1.

FIG. 9 is a flowchart showing a set of exemplary steps for using the speaking device of FIG. 1.

### DETAILED DESCRIPTION

The inventors have conceived novel technology that, for the purpose of illustration, is disclosed herein as applied in the context of underwater speaking devices. While the disclosed applications of the inventors' technology satisfy a long-felt but unmet need in the art of underwater speaking devices, it should be understood that the inventors' technology is not limited to being implemented in the precise manners set forth herein, but could be implemented in other manners without undue experimentation by those of ordinary skill in the art in light of this disclosure. Accordingly, the examples set forth herein should be understood as being illustrative only and should not be treated as limiting.

Implementations of the disclosed device may include a compact, collapsible, inflatable airspace that can be inflated while underwater either by lung air volume or from a semi-closed underwater breathing apparatus (e.g., Scuba) to provide a temporary underwater resonation chamber for verbal communication. Such implementations may be useful for experienced divers, during training by professional divemasters and instructors, or even for entertainment purposes by recreational swimmers in a pool or other setting. Other implementations may allow manual extension to provide a temporary underwater resonation chamber for verbal communication. Such implementations may be particularly effective, especially for divers that may elect to use only lung air volume to speak rather than a semi-closed underwater breathing apparatus.

Implementations of the disclosed device may include a soft mouthpiece which is designed to be placed below the nose and over the bottom of the chin to create a seal below a standard diving mask. An extendable tube is attached to the mouthpiece and provides a resonance chamber that allows for improved acoustics and transmission of verbal communications into the surrounding water. Implementations of the device may include ports and connectors for addition of compressed air from an air source to aid in purging water from the resonance chamber and/or to aid in breathing during use of the device. The soft mouthpiece may also be inverted to cover the nose and mouth of free swimmers without a mask.

Some implementations of the device include a low pressure inflator (“LPI”) port designed to attach to a low pressure inflator, the likes of which may be found on an inflator of a buoyancy control device for Scuba diving, and can be attached to Scuba equipment to allow for equipment assisted purging of water from the resonance chamber by operating of the LPI inflation button or other control. Some implementations of the device include a port shaped for easy attachment of a Scuba equipment regulator mouthpiece to allow for equipment assisted purging of water from the resonance chamber and may also provide limited demand valve breathing capability while using the device for verbal communications. Some implementations of the device may include a pad eye attachment, hook, loop, clip, or other structure or mechanical fixture to enable the device to be attached to a rope, belt, carabiner, or other object so that it may be easily stowed when not in use.

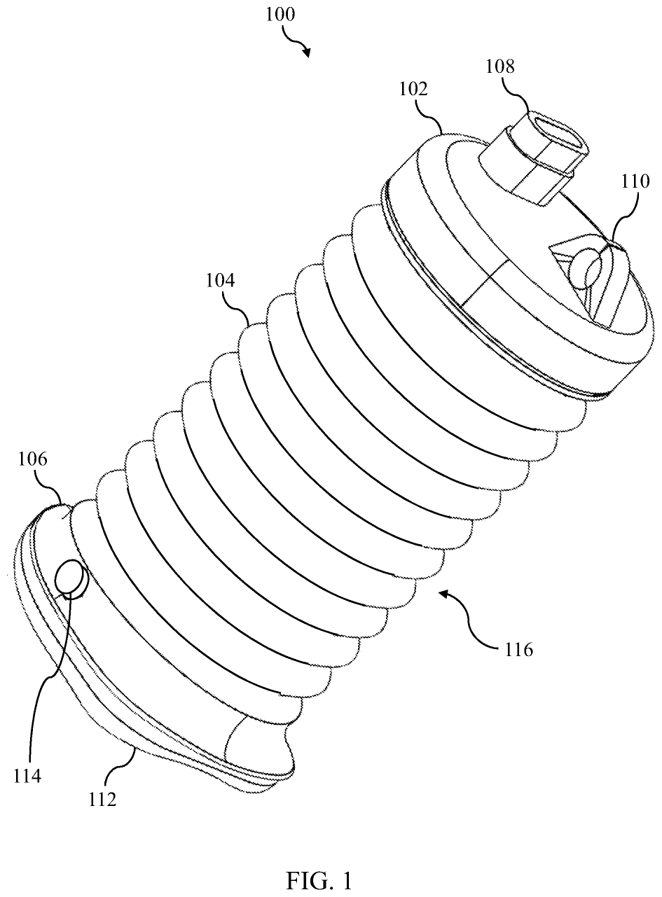

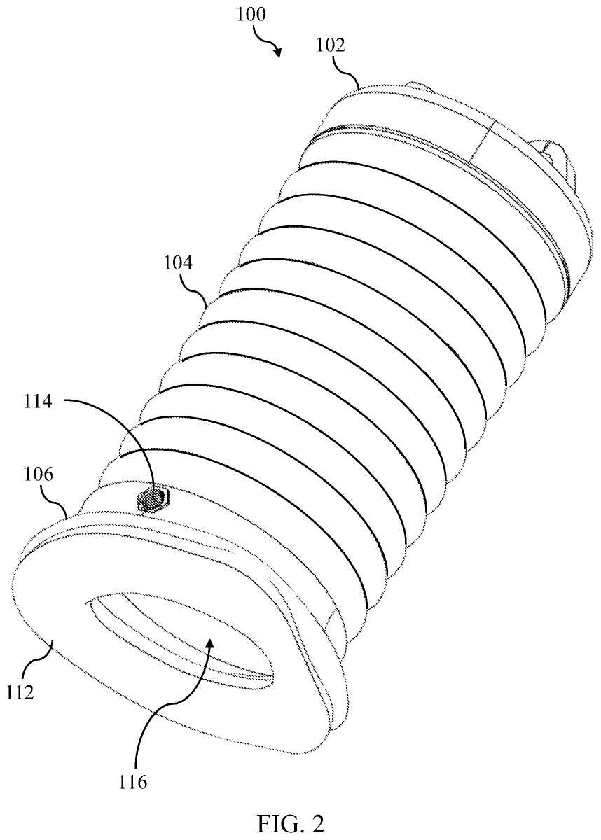

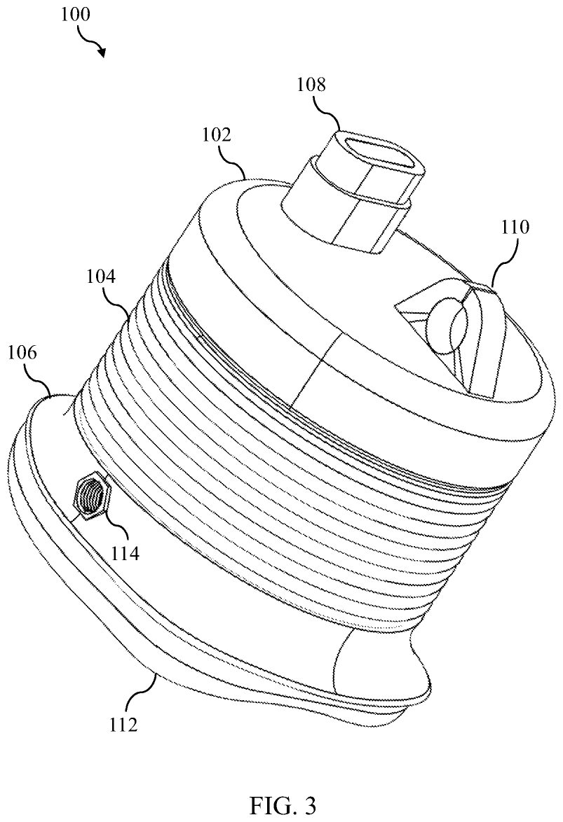

Turning now to the figures, FIGS. 1 and 2 show front and rear perspective views of an exemplary speaking device (100) in an extended state, while FIG. 3 shows a front perspective view of the speaking device (100) in a collapsed state. The speaking device (100) includes a cap portion (102), a resonance chamber (104), and a mouthpiece portion (106). As depicted, the resonance chamber (104) includes an accordion structure that allows the resonance chamber (104) to be collapsed to reduce the overall size of the device (100) when not in use or extended to increase the volume of a hollow resonance chamber interior (116) within the resonance chamber (104) during use. The resonance chamber (104) may be formed of various polymers, plastics, rubbers, or other flexible materials that allow the resonance chamber (104) to be extended or collapsed by hand, or by positive or negative pressure (e.g., the chamber may be “inflated” by positive pressure airflow into the device, or “deflated” by negative pressure).

While the resonance chamber (104) is shown as an accordion like collapsible structure in FIG. 1, it should be understood that other types of collapsible or extendible structures exist and may be used in varying implementations, and such variations will be apparent to those skilled in the art in light of this disclosure. For example, some implementations may utilize a telescoping or nested structure that allows for a wide range of extension or may use a flexible duct-like structure that extends as a function of rotation. Some implementations may also include a fixed-size static resonance chamber (104) that does not require extension or collapse between uses.

The cap portion (102) is coupled to one end of the resonance chamber (104) and includes a regulator port (108) that is configured to couple to an air supply of breathing equipment, and in FIG. 1 is shown as being configured to couple to a standard mouthpiece of a Scuba system. When coupled to the Scuba system via the regulator port (108), the Scuba system may be operated to provide airflow to the device in order to purge water from the interior (116) through a second stage regulator port, or to provide breathable air to a user while the device (100) is sealed to their face during use. Keeping the second stage regulator port at the lowest point when compared to the rest of the speaking device may be advantageous because doing so allows water purge out of the bottom of the speaking device. It should be understood that while the regulator port (108) depicted in FIG. 1 is shaped and sized to fit a standard mouthpiece of a Scuba system, the port characteristics may be adapted to fit any of varying types of air supply ports and/or may be configured to provide a universal fit across a number of air supply ports.

In some implementations, the regulator port (108) may include a bi-directional venting valve that allows for air intake from an attached air supply in a first direction, while also allowing for air and/or water to be purged from the interior (116) when output in a second opposite direction, such as may occur when a user exhales naturally during breathing, or exhales forcefully during purging of water. In some implementations, there may be an additional regulator port. The additional regulator port may be positioned proximately to the regulator port (108) at the end of the cap portion (102), or on a side of the end cap portion (102), or elsewhere on the end cap portion (102) and provides an additional for adding air and venting water. Implementations having two regulator ports (108) at different positions and orientations on the end cap portion (102) may be advantageous in allowing the device to be oriented in different ways in order to prevent or allow air to escape or water to purge from one or both of the ports). An additional regulator port also provides some advantages in better sound and venting when using the speaking device. In some implementations, one or more regulator ports may also extend or project from the sidewall of the end cap. The cap portion (102) also includes an attachment point (110) depicted in FIG. 1 as a molded portion of the cap (102) shaped to receive a rope, cord, carabiner clip, or other fixture means and allow the device (100) to be stowed when not in use without concerns about dropping or mishandling the device.

The mouthpiece portion (106) is attached to an end of the resonance chamber (104) opposite the cap portion (102), and includes a mouthpiece (112) and an LPI port (114) that is depicted in FIG. 1 as being filled with a cap plug, and is shown in FIGS. 2 and 3 with the cap plug removed as a threaded opening into the interior (116). The mouthpiece (112) is more clearly visible in FIG. 2, where an opening through the center of mouthpiece (112) into the interior (116) is visible. The mouthpiece (112) may be formed of a flexible polymer, plastic, rubber, or other material to allow for a comfortable seal to the face of the user. As one example, neoprene is a suitable material from which the mouthpiece (112) may be formed. As has been described above, the mouthpiece (112) is adapted to seal against the user's face and cover the mouth, or the nose and mouth (e.g., as opposed to inserting into the mouth, as some mouthpieces do). In some implementations, the mouthpiece (112) may be formed of two or more overlapping or folder layers such that it can be inverted or unfolded depending upon whether the user desires to cover their mouth, or their nose and mouth. Inverting or unfolding the mouthpiece (112) may be advantageous when the user is wearing only swim goggles with their nose exposed so the mouthpiece may cover the user's nose and mouth. Inverting the mouthpiece (112) may also provide additional comfort to users using a SCUBA mask.

The LPI port (114) is adapted to couple to an air supply, such as that provided by an LPI feature of a Scuba system or other breathing equipment. Where the LPI port (114) is implemented as a threaded opening, the LPI air supply may be coupled to the device prior to beginning a dive and left in place throughout the dive, as it provides a selectively fixed coupling or decoupling. In some implementations, the LPI port (114) may instead be a friction fit port capable of temporarily coupling with an air supply, similar to the regulator port (108), and may be coupled to such an air supply immediately before use. When an LPI feature of a breathing system is used with the LPI port (114), the user may fit the mouthpiece (112) so that it is sealed against their face, and then may operate the LPI feature to provided positive pressure airflow into the interior (114) to purge water via the regulator port (108), or to provide breathable air to the user. When not in use, the LPI port (114) may be plugged or capped.

As has been described, FIG. 3 is a front perspective view of the speaking device (100) in a collapsed state. In some implementations, the resonance chamber (104) may be extended from a minimum length to a maximum length of about twice the minimum length. In other implementations (e.g., telescoping), the resonance chamber may be extended to a maximum length of variable multiples of the minimum length (e.g., depending upon the number of nested portions). In varying implementations, the overall length of the device in its collapsed state (e.g., from the mouthpiece (112) to the distal tip of the regulator port (108)) is between about 2 inches and about 7 inches, between about 3 inches and about 6 inches, between about 4 inches and about 5 inches, or is about 4.75 inches. In varying implementations, the overall length of the device in its fully extended state (e.g., from the mouthpiece (112) to the distal tip of the regulator port (108)) is between about 4 inches and about 14 inches, between about 5 inches and about 13 inches, between about 6 inches and about 12 inches, between about 7 inches and about 11 inches, between about 8 inches and about 10 inches, or is about 9.25 inches.

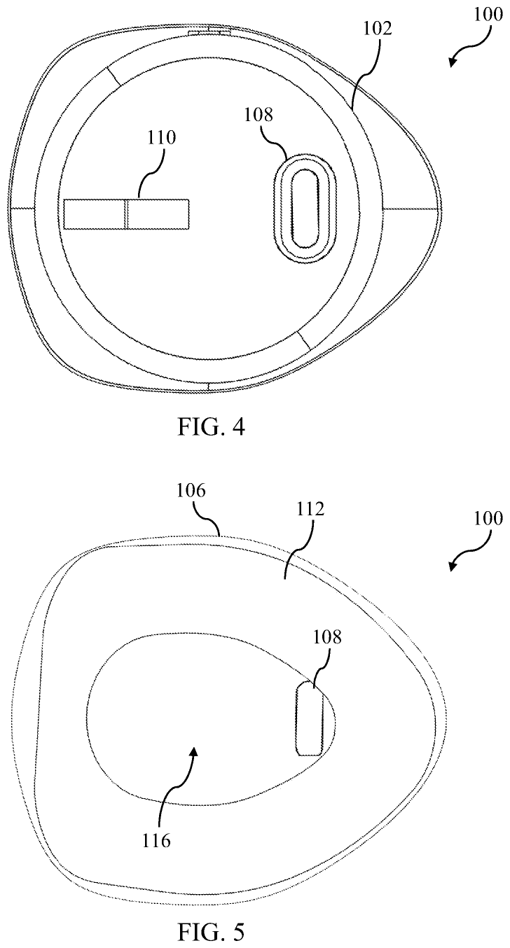

FIGS. 4 and 5 respectively show a top-down and bottom-up view of the speaking device of FIG. 1. A shape of the mouthpiece (112) suitable for sealing against the face (e.g., mouth, nose and mouth) of the user is visible in FIG. 5. An underside of the regulator port (108) is also visible through the interior (116) when viewing the underside of the cap portion (102) from below, through the opening of the mouthpiece (112).

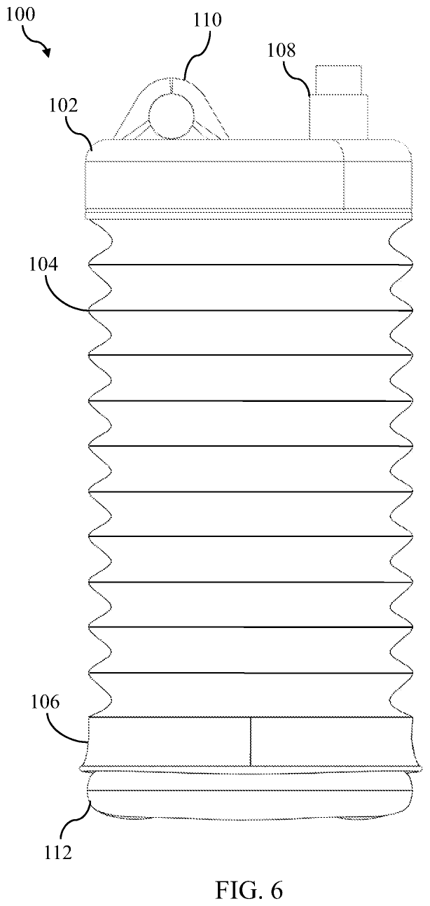

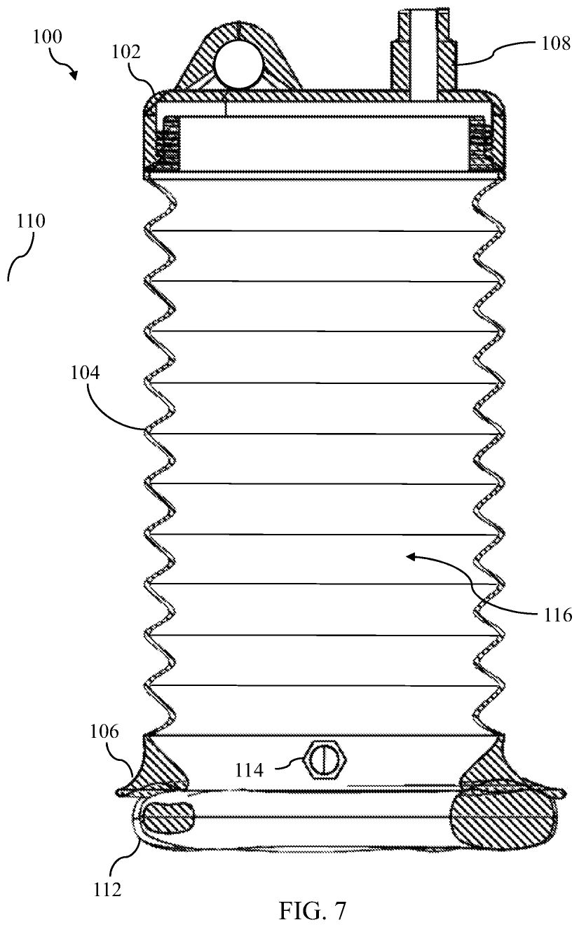

FIG. 6 is a side elevation view of the speaking device of FIG. 1, while FIG. 7 shows a cross-sectional view of the same. In FIG. 7 the interior (116) is exposed and is depicted as a hollow space within the resonance chamber (104). The regulator port (108) and LPI port (104) are each shown in FIG. 7 opening into the interior (116), thereby providing a path for air supply intake, or output of purged water or air from the interior (116), as may be applicable.

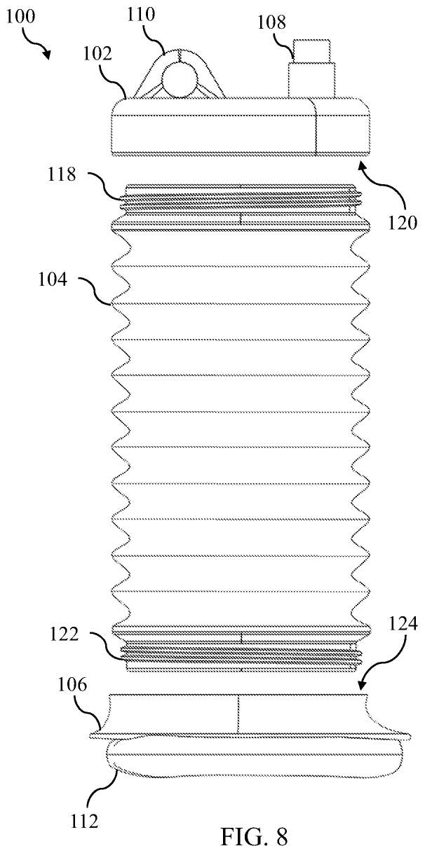

FIG. 8 is an exploded side elevation view of the speaking device of FIG. 1. As depicted in FIG. 8, the resonance chamber (104) includes an upper threaded portion (118) and a lower threaded portion (122) that are configured to couple the resonance chamber (104) to a threaded portion (120) of the cap portion (102) and a threaded portion (124) of the mouthpiece portion (106) respectively. The threaded portions (118, 122) of the resonance chamber (104) and the corresponding threaded portions (120, 124) of the other parts of the device are configured to provide a sealed coupling when assembled, and may include, for example, flexible gaskets, friction fit seals, or other sealing materials or structures such that there is no leakage of water and/or air via the threaded couplings when assembled. In some implementations, the threaded couplings are configured to allow the device (100) to be assembled and disassembled by hand, and to achieve a sealed threaded coupling when manually assembled.

In some implementations, the threaded couplings may be semi-permanently affixed by the user of adhesives or other sealants that provide a semi-permanent coupling and seal once dried, cured, or otherwise finished. In some implementations, the threaded couplings may be permanently affixed at the time of manufacture or final assembly by, for example, heating and cooling to fuse the coupled portions into a single piece. In some implementations, the device (100) may be manufactured or finally assembled in a manner that provides a permanent coupling of the cap portion (102) and mouthpiece portion (106) to the resonance chamber (104) without using corresponding threaded portions (e.g., the device (100) may be produced by a mold as a single piece, or otherwise permanently assembled as a unitary component). In some implementations, the mouthpiece (112) may be permanently fixed to the mouthpiece portion (106), and the entire mouthpiece portion (106) may be removed from the resonance chamber (104) and replaced in order to replace the mouthpiece (112) (e.g., due to wear and tear, or to provide a mouthpiece (112) of a different size or other characteristics). In some implementations, the mouthpiece (112) may be removable from the mouthpiece portion (106) and independently replaceable.

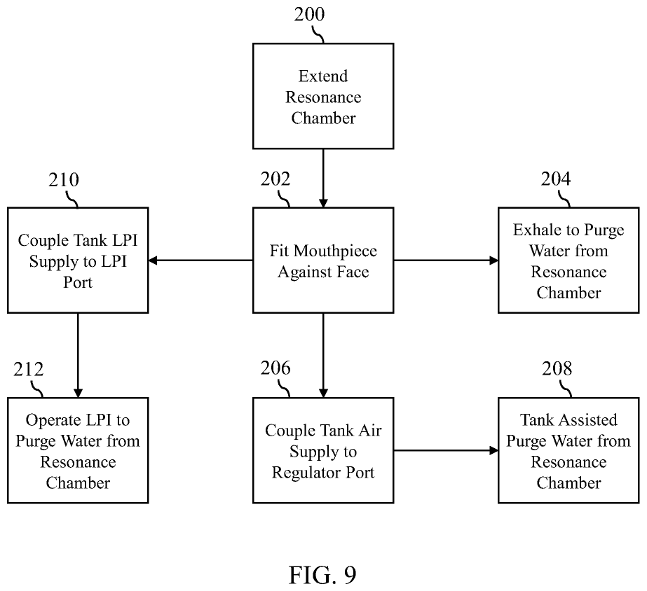

FIG. 9 is a flowchart showing a set of exemplary steps for using the speaking device of FIG. 1. Unless expressly stated or implicitly required, it should be understood that the steps of FIG. 9 may be performed in varying sequences and/or in parallel. In one exemplary use, the speaking device (100) may initially be carried by or attached to the user in a collapsed state, and prior to use may be extended (200) to its full length by extending the resonance chamber (104). Extending (200) the device may be accomplished manually by exerting an outward pulling force to each end of the device, or in some implementations may be accomplished by operating an air supply coupled to the regulator port (108) or LPI port (114) to provide positive pressure air flow and thereby inflate the resonance chamber (104). Additionally, the end cap (102) may be detached to provide easy access if filling the resonance chamber (104) by using free flow regulator air. Removing the end cap (102) is also advantageous because, in some circumstances, the speaker may be heard more clearly without the end cap (102) in place. While extending (200) the device (100) and preparing for use, it is advantageous to maintain the device pointed slightly downward (e.g., descending from its highest point at the mouthpiece (112) near the face of the user, to its lowest point at the regulator port (108) distal from the face of the user), with an angle of between about 15 degrees and about 45 degrees relative to the surface, or between about 20 degrees and about 40 degrees relative to the surface, or between about 25 degrees and about 35 degrees relative to the surface, or about 30 degrees relative to the surface.

The user may take a full breath and remove the mouthpiece or regulator of any current breathing apparatus from their mouth and the mouthpiece (112) of the device (100) may be fitted against the user's face (e.g., the mouth, or the mouth and nose). The user may exhale (204) into the mouthpiece (112) to purge water from the device via the regulator port (108) and provide a loosely sealed airspace in which the user can speak (e.g., potentially limited by the extent of their initial inhalation and/or any required exhalation to purge water from the chamber). In this manner, with several simple steps (200, 202, 204) the user is able to prepare and use the device (100) for short communication and may reverse those steps to return the breathing regulator to their mouth and stow the device (100) for future use with several additional simple steps.

Alternately, after extending (200) and/or fitting (202) the mouthpiece as has been described, the user may couple (206) the regulator of their air supply to the regulator port (108) and perform a tank assisted purge (208) of water from the chamber, allowing for prolonged communications paired with demand valve breathing through the device. While slightly more complex than the prior example, the preceding use advantageously provides the ability for prolonged communications not limited to a single breath, as the user may perform on demand breathing with their breathing apparatus via the regulator port (108) coupling. As with the prior example, the steps may be easily reversed when done communicating (e.g., regulator is decoupled from the regulator port (108) and placed back in mouth, device is collapsed).

Alternately, after extending (200) and/or fitting (202) the mouthpiece as has been described, the user may couple (210) an LPI air supply of their breathing equipment to the LPI port (114) of the device, as has been described (e.g., this may be performed on-demand, or may be configured prior to beginning the dive and left in place throughout). The user may then operate (212) the LPI feature of their breathing equipment to purge water from the resonance chamber via the regulator port (108) or around the mouthpiece (112) seal in order to provide the sealed airspace for communication and/or to provide breathable air, as may be desired. As with prior examples, the steps may be easily reversed when done communicating (e.g., LPI supply may be decoupled or left in place on the LPI port, regulator may be reinserted in mouth, etc.).

It should be understood that any one or more of the teachings, expressions, embodiments, examples, etc. described herein may be combined with any one or more of the other teachings, expressions, embodiments, examples, etc. that are described herein. The following-described teachings, expressions, embodiments, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

Having shown and described various embodiments of the present invention, further adaptations of the methods and systems described herein may be accomplished by appropriate modifications by one of ordinary skill in the art without departing from the scope of the present invention. Several such potential modifications have been mentioned, and others will be apparent to those skilled in the art. For instance, the examples, embodiments, geometrics, materials, dimensions, ratios, steps, and the like discussed above are illustrative and are not required. Accordingly, the scope of the present invention should be considered in terms of the following claims and is understood not to be limited to the details of structure and operation shown and described in the specification and drawings.

1. A speaking device comprising:
(a) a resonance chamber comprising a hollow interior, wherein the resonance chamber is configured to be selectively longitudinally extended to a maximum length and collapsed to a minimum length;
(b) a cap portion coupled to a distal end of the resonance chamber, and comprising a regulator port in fluid communication with the hollow interior of the resonance chamber, wherein the regulator port is configured to selectively couple to an air supply regulator of a breathing apparatus and thereby provide an air supply to the interior; and
(c) a mouthpiece portion coupled to a proximal end of the resonance chamber, and comprising a flexible mouthpiece configured to seal against a face of the user and cover the user's mouth, wherein the flexible mouthpiece is in fluid communication with the hollow interior of the resonance chamber such that an exhalation from the mouth of the user into the interior purges fluid from the interior via the regulator port when the regulator port is not coupled to the air supply regulator.
